(19) United States
(12) Patent Application Publication
(10) Pub. No.: US 2015/0348190 A1
(43) Pub. Date: Dec. 3, 2015

(54) SYSTEMS AND METHODS FOR ENHANCED USER INTERFACE FOR PLACING AN ORDER

(71) Applicant: E*TRADE FINANCIAL CORPORATION, New York, NY (US)

(72) Inventor: Steven ABELL, Fremont, CA (US)

(73) Assignee: E*TRADE FINANCIAL CORPORATION, New York, NY (US)

(21) Appl. No.: 14/291,817

(22) Filed: May 30, 2014

(51) Int. Cl. G06Q 40/04; G06F 3/0484; G06F 3/0485

(52) U.S. Cl. CPC G06Q 40/04; G06F 3/04847; G06F 3/04842; G06F 3/0485

(57) ABSTRACT

A system to provide an enhanced user interface for placing an order, for example an online purchase or sale order, includes a user input device configured to generate position data and a processor coupled to the user input device. The processor receives the position data from the user input device and generates a first order variable and a second order variable based on the position data. The processor changes the first order variable in response to the position data indicating movement of the user input device in the X-axis and changes the second order variable in response to the position data indicating movement of the user input device in the Y- axis. The order variables may relate to an order price and an order quantity.

### CROSS-REFERENCE TO RELATED APPLICATIONS

None.

### BACKGROUND

In conventional trading interfaces for buying and selling of securities, such as a candlestick chart interface, clicking on the screen with a mouse and dragging up or down (i.e., on the y-axis) adjusts the desired price for the security represented by the chart. Once a price is set, a dialog box opens on the screen and the user is able to enter an order quantity to either buy or sell.

### SUMMARY

In order to address certain problems in the prior art, at least some embodiments of the present disclosure are directed toward a system to provide an enhanced user interface for placing an order. The system includes a user input device configured to generate position data and a processor coupled to the user input device. The processor receives the position data from the user input device and generates a first order variable and a second order variable based on the position data. The processor changes the first order variable in response to the position data indicating movement of the user input device in the X-axis and changes the second order variable in response to the position data indicating movement of the user input device in the Y-axis.

Other embodiments of the present disclosure are directed toward a method to provide an enhanced user interface for placing an order. The method includes generating position data by a user input device, receiving the position data from the user input device by a processor, generating a first order variable and a second order variable based on the position data, changing the first order variable in response to the position data indicating movement of the user input device in the X-axis, and changing the second order variable in response to the position data indicating movement of the user input device in the Y-axis.

Still other embodiments of the present disclosure are directed toward a non-transitory computer-readable medium containing instructions that, when executed by a processor, cause the processor to perform certain steps. In certain embodiments, the processor receives position data from a user input device, generates a first order variable and a second order variable based on the position data, changes the first order variable in response to the position data indicating movement of the user input device in the X-axis, and changes the second order variable in response to the position data indicating movement of the user input device in the Y-axis.

### BRIEF DESCRIPTION OF THE DRAWINGS

For a detailed description of exemplary embodiments of the invention, reference will now be made to the accompanying drawings in which:

FIG. 1 shows a block diagram of a system for providing an enhanced user interface for chart trading in accordance with various embodiments;

FIG. 2 shows a flow chart of a method for providing an enhanced user interface for chart trading in accordance with various embodiments; and

FIG. 3 shows block diagram including a non-transitory computer-readable medium for implementing an enhanced user interface for chart trading in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION

The following discussion is directed to various exemplary embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

In a conventional chart trading interface, such as a candlestick chart, a desired price at which to buy or sell a security is set by clicking and dragging a cursor (e.g., using a conventional mouse input device). This price is referred to as an “order price.” However, a desired quantity of the security to buy or sell at the order price, referred to as an “order quantity,” is set when the user is prompted to and subsequently does enter the quantity into a dialog box. Such an interface is cumbersome and requires a more complex procedure to input the required information to complete a securities order.

In accordance with various embodiments of the present disclosure, an enhanced user interface for chart trading is provided. In certain embodiments, the user interface is enhanced by utilizing movement of the mouse or other user input device along a first axis as an input that controls or modifies the value of a first order variable (e.g., one of order price and order quantity) and utilizing movement of the user input device along a second axis as an input that controls or modifies the value of a second order variable (e.g., the other of order price and order quantity). For example, movement of a user input device that corresponds to dragging a cursor along the y-axis of the chart interface adjusts a desired order price, whereas movement of the user input device that corresponds to dragging the cursor along the x-axis of the chart adjusts a desired order quantity. As a result, a user is able to more quickly interact with the chart interface and no longer needs to key in an order quantity to a dialog box after the desired order price is set. In certain embodiments, a dynamic label may be displayed on or near the chart that indicates to the user the currently selected order price and/or order quantity as the user input device, and thus cursor, are moved by the user.

Further, in some embodiments, the scale along the x-axis may be configured by the user. For example, the user may adjust minimum and maximum order quantity values as well as values controlling the quantity increment along the x-axis. The x-axis may also be configured, for example, to adjust quantity on an exponential or other non-linear scale, or according to the price range of various securities (e.g., penny stocks vs. Google), or according to the amount of money available in the user's trading account. Still further, in some embodiments additional user input (e.g., using the scroll wheel on a mouse) may be used to change the order type for a particular order, or other variables associated with securities trading.

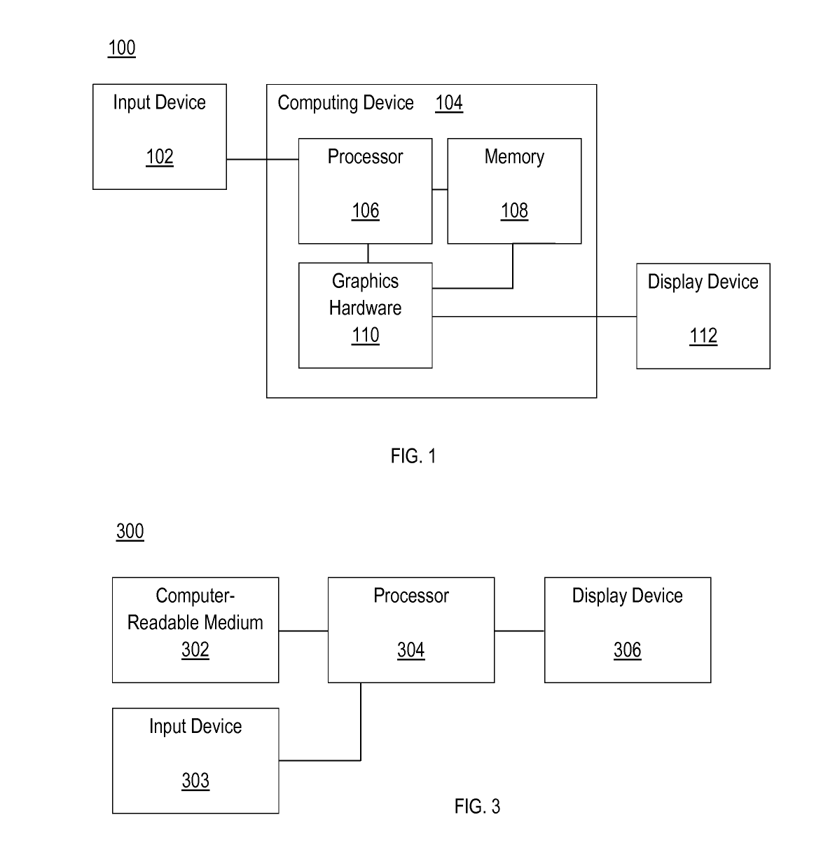

Turning now to FIG. 1, a system 100 to provide an enhanced user interface for placing an order is shown in accordance with various embodiments. As explained above, the order may be, for example, a securities order such as an order to buy or sell a publicly-traded stock. The system 100 includes a user input device 102 coupled to a computing device 104, which is in turn coupled to a display device 112. The user input device 102 may be one of many such devices known in the art, such as a mouse, trackball, touchpad. In some embodiments the user input device 102 is integrated with the display device 112, such as in a touchscreen application. The user input device 102 generates position data that indicates a change in position of the user input device 102, for example due to manipulation by the user. The position data may indicate a change in relative position of the user input device 102 as would be the case where the user input device 102 is a mouse; however, the position data may also indicate an absolute position where the user input device 102 is a touchscreen and the position data is generated as a result of the user touching a point on the screen. In accordance with embodiments of the present disclosure, the position data is utilized by the computing device to, among other things, control the position of a cursor displayed on the display device 112.

The computing device 104 includes a processor 106, a memory 108, and graphics hardware 110, which are commonly coupled to one another. The computing device 104 may be any of a variety of devices, such as a desktop computer, a laptop computer, a tablet computer, a smartphone, or the like. As explained above, the computing device 104 is coupled to a display device 112. In some cases, the display device 112 may be a monitor separate from the computing devices 104, while in other cases the display device 112 is integrated with the computing device 104 such as where the computing device 104 is a laptop computer or a tablet computer.

The processor 106 is coupled to and receives data from the user input device 102, such as position data or data that indicates movement of the user input device 102 by a user. For example, if the user moves the user input device 102 to the left, the user input device 102 generates and the processor 106 receives data that indicates the amount of motion to the left. Subsequently, the processor 106 may interface with graphics hardware 110 to cause a cursor shown on display device 112 to move correspondingly to the left. The foregoing is one example of the interface between the user input device 102, the processor 106, the graphics hardware 110, and the display device 112, but it will be appreciated that this functionality extends to movement in other directions as well.

In accordance with various embodiments, the processor 106 also executes a chart trading application. In some cases, the chart trading application may be run locally on the processor 106, while in others the chart trading application is accessed remotely by the processor 106 through a network such as the Internet (e.g., through a web browser running on the computing device 104). The processor 106 generates first and second order variables based on the position data. For example, where the chart trading application is a candlestick chart application, the processor 106 may generate a variable that corresponds to an order price that is related to the vertical position of a cursor that is controlled by the user input device 102. The processor 106 may store the variables, along with other data, in the memory 108.

In some cases, a secondary input such as a mouse click signifies to the processor 106 that the user desires to initiate an order at a particular order price. Such an input may be referred to as a “user selection action,” as it represents the user's intent to select an object in the chart trading application interface or otherwise trigger an action. For example, following the user selection action, the user may manipulate the vertical position of the cursor until a desired price is reached, which may be displayed alongside the cursor or elsewhere within the chart trading application, and upon clicking the user input device 102, the current order price is selected and entry of an order quantity is requested of the user. The processor 106 may be configured to ignore incidental movement in the horizontal direction. Alternatively, the user may trigger an order price manipulation by clicking and holding a button on the user input device 102, at which point vertical movement of the cursor adjusts the order price variable, and upon releasing the button on the user input device 102, the current order price is selected and entry of an order quantity is requested of the user. As explained above, conventionally the user was required to key an order quantity value into a dialog box that is accessed once an order price is selected; however, such a method of entering an order quantity is both cumbersome and counterintuitive.

In accordance with various embodiments, rather than prompting the user to key in an order quantity in a dialog box, the presently disclosed system 100 allows the user to select an order quantity through movement of the user input device 102 in a direction that is different than the direction that modifies and selects an order price. Extending the above example, after the order price is set or selected, a secondary input such as a mouse click signifies to the processor 106 that the user desires to select a particular order quantity. For example, the user may manipulate the horizontal position of the cursor until a desired quantity is reached, which may be displayed alongside the cursor or elsewhere within the chart trading application, and upon clicking the user input device 102, the current order quantity is selected and confirmation of the order is requested of the user. The processor 106 may be configured to ignore incidental movement in the vertical direction. Alternatively, the user may trigger an order quantity manipulation by clicking and holding a button on the user input device 102, at which point horizontal movement of the cursor adjusts the order quantity variable, and upon releasing the button on the user input device 102, the current order quantity is selected and confirmation of the order is requested of the user. Further, in certain embodiments other order variable selections such as order type (e.g., market, limit, or stop), order duration (e.g., a period of time after which the order expires), and the like may be selected prior to confirmation of the order.

Although the above example describes consecutive selection and entry of order variables, certain embodiments of the present disclosure are directed to concurrent selection and entry of order variables. For example, a secondary input such as a mouse click signifies to the processor 106 that the user desires to initiate an order. Subsequently, the user may manipulate both the vertical and horizontal positions of the cursor until a desired order price and quantity are reached, which may be displayed alongside the cursor or elsewhere within the chart trading application interface, and upon clicking the user input device 102, the current order price and quantity are selected and confirmation of the order is requested of the user. Also similar to above, the user may trigger order price and quantity manipulation by clicking and holding a button on the user input device 102, at which point vertical movement of the cursor adjusts the order price variable while horizontal movement of the cursor adjusts the order quantity variable, and upon releasing the button on the user input device 102, the current order price and quantity are selected and confirmation of the order quantity is requested of the user.

Thus, in accordance with various embodiments, the processor 106 modifies a first order variable (e.g., order price) in response to position data from the user input device 102 indicating movement of the user input device 102 in a vertical direction (e.g., the Y-axis of the chart trading application interface). Similarly, the processor 106 modifies a second order variable (e.g., order quantity) in response to position data from the user input device 102 indicating movement of the user input device 102 in a horizontal direction (e.g., the X-axis of the chart trading application interface).

It will be appreciated that other methods of order price and quantity selection are within the scope of the present disclosure, but that generally movement of the user input device 102 causes the processor to generate and modify order variables, for example representing an order price and an order quantity.

In addition to the above-described embodiments, further manipulation of the user input device 102 results in the generation of data that is received by the processor 106, which in turn may generate or modify additional order variables beyond the price and quantity variables described above. For example, certain user input devices 102 may include additional buttons and/or a scroll wheel that serve to generate additional data related to a user's input actions. In particular, a scroll wheel on a mouse may be used to generate and manipulate a third order variable such as an order type. In one embodiment, after an order price and quantity have been selected using the user input device 102, the user may manipulate the scroll wheel of the user input device 102 to select or modify an order type, such as a market order, a limit order, a stop order, or the like. Then, when the desired order type is selected, the user may continue to confirm the order though the chart trading application interface. In this way, further control over order variables is enabled through manipulation of the input device 102 and corresponding interaction with the computing device 104.

Referring back to the above described user selection actions, in some embodiments after receiving an indication from the user input device 102 of a user selection action occurring (e.g., a mouse click), the processor 106 generates a confirmation dialog box for display on the display device 112. For example, the user may move the user input device 102 until a desired order price and quantity have been selected in the chart trading application interface and then click a mouse button, which causes the processor 106 to generate a dialog to confirm the selected price and quantity and progress through the order placement process. In other embodiments, the processor 106 may generate a confirmation dialog box as a result of first receiving, and then no longer receiving, an indication of the user selection action. For example, the user holds the mouse button during order price and quantity selection and, when the user releases the button upon reaching a desired order price and quantity, the processor 106 generates a dialog to confirm the selected price and quantity and progresses through the order placement process. Although the foregoing are exemplary embodiments of utilizing a user selection action to control aspects of the chart trading interface, the present disclosure is not limited to only those combinations of user selection actions and other such interactions are within the scope of the present disclosure.

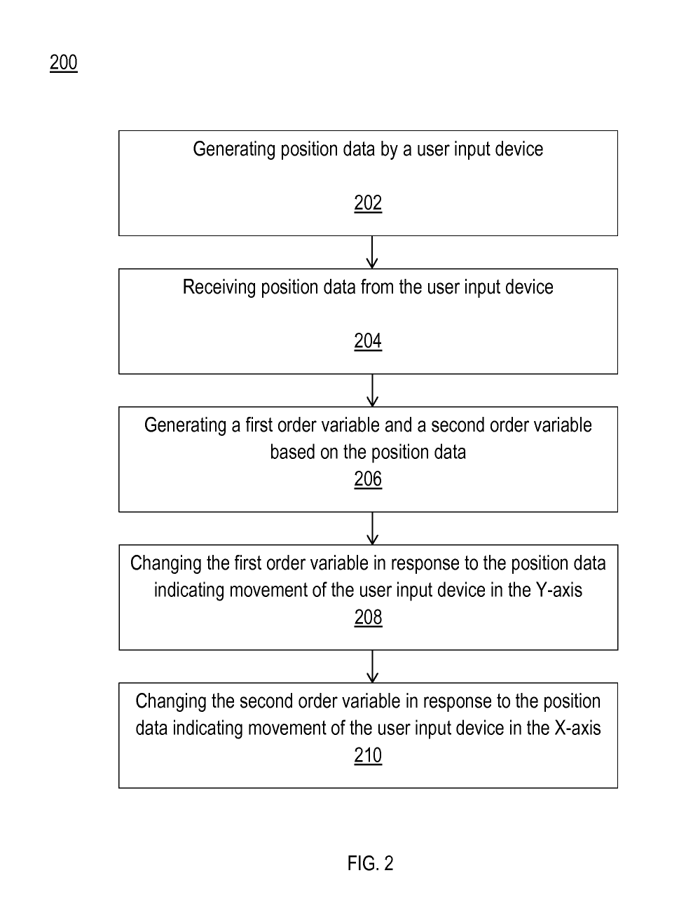

Turning now to FIG. 2, a method 200 for providing an enhanced user interface for placing an order is shown in accordance with various embodiments. The method 200 begins in block 202 with generating position data, for example by a user input device 102 as described above. The method 200 continues in block 204 with receiving the position data at a processor 106 from the user input device 102. In block 206, the method continues with the processor 106 generating a first order variable and a second order variable based on the received position data. For example, the first order variable might be a value that corresponds to an order price while the second order variable might be a value that corresponds to an order quantity. The method 200 then continues in block 208 with changing the first order variable (e.g., order price) in response to the position data generated by the user input device 102 indicating movement or manipulation of the user input device 102 in the vertical direction or Y-axis. As above, incidental movement in the horizontal direction may be ignored in block 208. Similarly, in block 210, the method 200 includes changing the second order variable (e.g., order quantity) in response to the position data generated by the user input device 102 indicating movement or manipulation of the user input device 102 in the horizontal direction or X-axis. Again, incidental movement in the vertical direction may be ignored in block 210. Further, in some embodiments, both horizontal and vertical movement or manipulation are monitored by the processor 106 at the same time, and thus the processor concurrently modifies both the first and second order variables.

Further, the method 200 may also include the processor 106 receiving an indication of a user selection action, such as a mouse click, from the user input device 102. As a result of receiving the indication, the method 200 also includes the processor generating a confirmation dialog for display on the display device 112, for example to confirm the user's selection of order variables using the above method steps. The method 200 may also include the processor 106 receiving an indication of a user selection action, such as a mouse click, from the user input device 102. As a result of no longer receiving the indication, such as when the user finally releases the mouse button, the method 200 includes the processor generating a confirmation dialog for display on the display device 112, for example to confirm the user's selection of order variables using the above method steps.

The method 200 may also include the user input device 102 generating additional input data, such as scroll data from a scroll wheel that is received by the processor 106. As a result, the method 200 includes the processor generating or modifying additional order variables beyond the price and quantity variables described above. In particular, a scroll wheel on a mouse may be used to generate and manipulate a third order variable such as an order type. In one embodiment, after an order price and quantity have been selected using the user input device 102, the method includes receiving an indication that the user is manipulating the scroll wheel of the user input device 102 to select or modify an order type, such as a market order, a limit order, a stop order, or the like. Then, when the desired order type is selected, the method 200 may continue to confirm the order though the chart trading application interface. In this way, further control over order variables is enabled through manipulation of the input device 102 and corresponding interaction with the computing device 104.

FIG. 3 shows another system 300 to provide an enhanced user interface for placing an order in accordance with various embodiments. The system 300 is similar to the system 100 described with respect to FIG. 1, however certain components are omitted for simplicity. The system 300 includes a computer-readable medium 302 coupled to a processor 304, which is in turn coupled to a display device 306. The computer-readable medium 302 may be any non-transitory medium known in the art. In accordance with various embodiments of the present disclosure, the computer-readable medium 302 contains instructions that, when executed by the processor 304, cause the processor 304 to perform all or a portion of the various methods described above, including receiving user input by way of the user input device 303 and providing and generating a chart trading application interface on the display device 306.

The above discussion is meant to be illustrative of certain principles and various exemplary embodiments of the present invention. Numerous variations and modifications will become apparent to those skilled in the art once the above disclosure is fully appreciated. For example, in certain embodiments the disclosed systems and methods for providing an enhanced user interface for placing an order may permit the user to modify the scale of the price and/or quantity axes. As another example, although the above is generally directed toward modifying an order price variable based on motion of a user input device in one direction and modifying an order quantity variable based on motion of a user input device in another direction, the type of order variable manipulated may be reassigned or otherwise altered within the scope of the present disclosure. Further, while generally described with respect to motion in fixed axes (e.g., X-axis and Y-axis), it should be appreciated that other types of motion of the user input device may be correspondingly assigned or related to various variables or fields that contribute to the ultimate generation of an order. Still further, while generally described with respect to a securities order, embodiments of the present disclosure may be directed toward populating fields of various types of orders and, in particular, leveraging multiple types of movement of a user input device to effect such population. It is intended that the following claims be interpreted to embrace all such variations and modifications.

What is claimed is:

1. A system to provide an user interface for placing an order, comprising:
a user input device configured to generate position data; and
a processor coupled to the user input device and configured to:
receive the position data from the user input device;
generate a first order variable and a second order variable based on the position data;
wherein the processor is configured to change the first order variable in response to the position data indicating movement of the user input device in the Y-axis; and
wherein the processor is configured to change the second order variable in response to the position data indicating movement of the user input device in the X-axis.

2. The system of claim 1 wherein the processor is configured to change the first and second order variables in response to the position data indicating simultaneous movement of the user input device in both the X-axis and the Y-axis.

3. The system of claim 1 wherein the processor is further configured to:
receive an indication of a user selection action from the user input device; and
generate, as a result of receiving the indication, a confirmation dialog for display on a display device.

4. The system of claim 1 wherein the processor is further configured to:
receive an indication of a user selection action from the user input device; and
generate, as a result of first receiving the indication and subsequently no longer receiving the indication, a confirmation dialog for display on a display device.

5. The system of claim 1 wherein the user input device is further configured to generate scroll data and the processor is further configured to receive the scroll data and generate a third order variable based on the scroll data.

6. The system of claim 5 wherein the processor is configured to change the third order variable in response to a change in the scroll data.

7. A method to provide an enhanced user interface for placing an order, comprising:
generating, by a user input device, position data; and
receiving, by a processor, the position data from the user input device;
generating, by the processor, a first order variable and a second order variable based on the position data;
changing, by the processor, the first order variable in response to the position data indicating movement of the user input device in the Y-axis; and
changing, by the processor, the second order variable in response to the position data indicating movement of the user input device in the X-axis.

8. The method of claim 7 further comprising changing, by the processor, the first and second order variables in response to the position data indicating simultaneous movement of the user input device in both the X-axis and the Y-axis.

9. The method of claim 7 further comprising:
receiving, by the processor, an indication of a user selection action from the user input device; and
generating, by the processor, as a result of receiving the indication, a confirmation dialog for display on a display device.

10. The method of claim 7 further comprising:
receiving, by the processor, an indication of a user selection action from the user input device; and
generating, by the processor and as a result of first receiving the indication and subsequently no longer receiving the indication, a confirmation dialog for display on a display device.

11. The method of claim 7 further comprising:
generating, by the user input device, scroll data; and
receiving, by the processor, the scroll data and generating a third order variable based on the scroll data.

12. The method of claim 11 further comprising changing, by the processor, the third order variable in response to a change in the scroll data.

13. A non-transitory computer-readable medium containing instructions that, when executed by a processor, cause the processor to:
receive position data from a user input device;
generate a first order variable and a second order variable based on the position data;
change the first order variable in response to the position data indicating movement of the user input device in the Y-axis; and
change the second order variable in response to the position data indicating movement of the user input device in the X-axis.

14. The non-transitory computer-readable medium of claim 13 wherein the instructions being executed by the processor cause the processor to change the first and second order variables in response to the position data indicating simultaneous movement of the user input device in both the X-axis and the Y-axis.

15. The non-transitory computer-readable medium of claim 13 wherein the instructions being executed by the processor cause the processor to:
receive an indication of a user selection action from the user input device; and
generate, as a result of receiving the indication, a confirmation dialog for display on a display device.

16. The non-transitory computer-readable medium of claim 13 wherein the instructions being executed by the processor cause the processor to:
receive an indication of a user selection action from the user input device; and
generate, as a result of first receiving the indication and subsequently no longer receiving the indication, a confirmation dialog for display on a display device.

17. The non-transitory computer-readable medium of claim 13 wherein the user input device is further configured to generate scroll data and wherein the instructions being executed by the processor cause the processor to receive the scroll data and generate a third order variable based on the scroll data.

18. The non-transitory computer-readable medium of claim 17 wherein the instructions being executed by the processor cause the processor to change the third order variable in response to a change in the scroll data.
